(19) United States
(12) Patent Application Publication
(10) Pub. No.: US 2024/0265718 A1
(43) Pub. Date: Aug. 8, 2024

(54) METHOD OF TRAINING TEXT DETECTION MODEL, METHOD OF DETECTING TEXT, AND DEVICE

(71) Applicant: Beijing Baidu Netcom Science Technology Co., Ltd., Beijing (CN)

(72) Inventors: Xiaoqiang ZHANG, Beijing (CN); Xiameng QIN, Beijing (CN); Chengquan ZHANG, Beijing (CN); Kun YAO, Beijing (CN)

(21) Appl. No.: 18/041,370

(22) PCT Filed: Apr. 22, 2022
(86) PCT No.: PCT/CN2022/088393

§ 371 Date: Feb. 10, 2023

(30) Foreign Application Priority Data
Aug. 13, 2021 (CN) 202110934294.5

(51) Int. Cl. G06V 30/19; G06V 10/77; G06V 10/82

(52) U.S. Cl. CPC G06V 30/19127; G06V 10/7715; G06V 10/82

(57) ABSTRACT

A method training a text detection model and a method of detecting a text. The training method includes: inputting a sample image into a text feature extraction sub-model of a text detection model to obtain a text feature of a text in the sample image, the sample image having a label indicating an actual position information and an actual category; inputting a predetermined text vector into a text encoding sub-model of the text detection model to obtain a text reference feature; inputting the text feature and the text reference feature into a decoding sub-model of the text detection model to obtain a text sequence vector; inputting the text sequence vector into an output sub-model of the text detection model to obtain a predicted position information and a predicted category; and training the text detection model based on the predicted and actual categories, the predicted and actual position information.

This application is a Section 371 National Stage Application of International Application No. PCT/CN2022/088393, filed on Apr. 22, 2022, entitled “METHOD AND APPARATUS OF TRAINING TEXT DETECTION MODEL, METHOD AND APPARATUS OF DETECTING TEXT, AND DEVICE”, which claims priority to Chinese Patent Application No. 202110934294.5, filed on Aug. 13, 2021, which are incorporated herein by reference in their entirety.

### TECHNICAL FIELD

The present disclosure relates to a field of an artificial intelligence technology, in particular to fields of computer vision and deep learning technologies, and may be applied to image processing, image recognition and other scenarios.

### BACKGROUND

With a development of a computer technology and a network technology, a deep learning technology has been widely used in many fields. For example, the deep learning technology may be used to detect a text in an image to determine a position of the text in the image. As a target of a visual object, a text may present diverse features in font, size, color, direction, and so on, which puts forward a high requirement for a feature modeling ability of the deep learning technology.

### SUMMARY

Based on this, the present disclosure provides a method of training a text detection model, a method of detecting a text by using a text detection model, a device and a storage medium for improving a text detection effect, which may be applied to a variety of scenes.

According to an aspect of the present disclosure, a method of training a text detection model is provided, where the text detection model includes a text feature extraction sub-model, a text encoding sub-model, a decoding sub-model and an output sub-model, and the method includes: inputting a sample image containing a text into the text feature extraction sub-model to obtain a first text feature of the text contained in the sample image, where the sample image has a label indicating an actual position information of the text contained in the sample image and an actual category for the actual position information; inputting a predetermined text vector into the text encoding sub-model to obtain a first text reference feature; inputting the first text feature and the first text reference feature into the decoding sub-model to obtain a first text sequence vector; inputting the first text sequence vector into the output sub-model to obtain a predicted position information of the text contained in the sample image and a predicted category for the predicted position information; and training the text detection model based on the predicted category, the actual category, the predicted position information and the actual position information.

According to another aspect of the present disclosure, a method of detecting a text by using a text detection model is provided, where the text detection model includes a text feature extraction sub-model, a text encoding sub-model, a decoding sub-model and an output sub-model, and the method includes: inputting an image to be detected containing a text into the text feature extraction sub-model to obtain a second text feature of the text contained in the image to be detected; inputting a predetermined text vector into the text encoding sub-model to obtain a second text reference feature; inputting the second text feature and the second text reference feature into the decoding sub-model to obtain a second text sequence vector; and inputting the second text sequence vector into the output sub-model to obtain a position of the text contained in the image to be detected, where the text detection model is trained using the method of training the text detection model described above.

According to another aspect of the present disclosure, an electronic device is provided, including: at least one processor; and a memory communicatively connected to the at least one processor, where the memory stores instructions executable by the at least one processor, and the instructions, when executed by the at least one processor, cause the at least one processor to implement the method of training the text detection model and/or the method of detecting the text by using the text detection model provided by the present disclosure.

According to another aspect of the present disclosure, a non-transitory computer-readable storage medium having computer instructions therein is provided, and the computer instructions are configured to cause a computer to implement the method of training the text detection model and/or the method of detecting the text by using the text detection model provided by the present disclosure.

It should be understood that content described in this section is not intended to identify key or important features in embodiments of the present disclosure, nor is it intended to limit the scope of the present disclosure. Other features of the present disclosure will be easily understood through the following description.

### BRIEF DESCRIPTION OF THE DRAWINGS

The accompanying drawings are used for better understanding of the solution and do not constitute a limitation to the present disclosure, in which:

FIG. 1 shows a schematic diagram of an application scenario of a method and an apparatus of training a text detection model and a method and an apparatus of detecting a text by using a text detection model according to embodiments of the present disclosure;

FIG. 2 shows a schematic flowchart of a method of training a text detection model according to embodiments of the present disclosure;

FIG. 3 shows a schematic structural diagram of a text detection model according to embodiments of the present disclosure;

FIG. 4 shows a schematic structural diagram of an image feature extraction network according to embodiments of the present disclosure;

FIG. 5 shows a schematic structural diagram of a feature processing unit according to embodiments of the present disclosure;

FIG. 6 shows a schematic diagram of determining a loss of a text detection model according to embodiments of the present disclosure;

FIG. 7 shows a schematic flowchart of a method of detecting a text by using a text detection model according to embodiments of the present disclosure;

FIG. 8 shows a structural block diagram of an apparatus of training a text detection model according to embodiments of the present disclosure;

FIG. 9 shows a structural block diagram of an apparatus of detecting a text by using a text detection model according to embodiments of the present disclosure; and

FIG. 10 shows a block diagram of an electronic device for implementing a method of training a text detection model and/or a method of detecting a text by using a text detection model according to embodiments of the present disclosure.

### DETAILED DESCRIPTION OF EMBODIMENTS

Exemplary embodiments of the present disclosure will be described below with reference to accompanying drawings, which include various details of embodiments of the present disclosure to facilitate understanding and should be considered as merely exemplary. Therefore, those of ordinary skilled in the art should realize that various changes and modifications may be made to embodiments described herein without departing from the scope and spirit of the present disclosure. Likewise, for clarity and conciseness, descriptions of well-known functions and structures are omitted in the following description.

The present disclosure provides a method of training a text detection model. The text detection model includes a text feature extraction sub-model, a text encoding sub-model, a decoding sub-model, and an output sub-model. The training method includes a text feature obtaining stage, a reference feature obtaining stage, a sequence vector obtaining stage, a text information determination stage, and a model training stage. In the text feature obtaining stage, a sample image containing a text is input into the text feature extraction sub-model to obtain a first text feature of the text contained in the sample image. The sample image has a label indicating an actual position information of the text contained in the sample image and an actual category for the actual position information. In the reference feature obtaining stage, a predetermined text vector is input into the text encoding sub-model to obtain a first text reference feature. In the sequence vector obtaining stage, the first text feature and the first text reference feature are input into the decoding sub-model to obtain a first text sequence vector. In the text information determination stage, the first text sequence vector is input into the output sub-model to obtain a predicted position information of the text contained in the sample image and a predicted category for the predicted position information. In the model training stage, the text detection model is trained based on the predicted category, the actual category, the predicted position information and the actual position information.

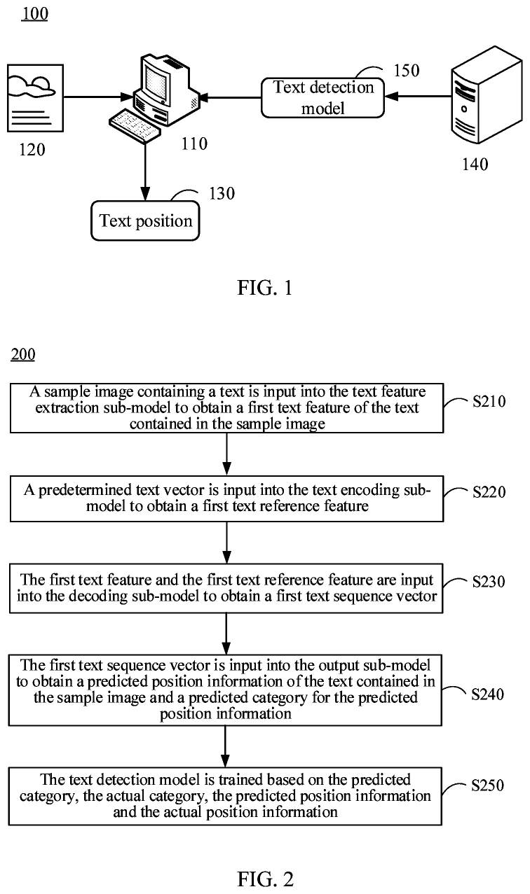

An application scenario of the methods and apparatuses provided by the present disclosure will be described below with reference to FIG. 1.

FIG. 1 shows a schematic diagram of an application scenario of a method and an apparatus of training a text detection model and a method and an apparatus of detecting a text by using a text detection model according to embodiments of the present disclosure.

As shown in FIG. 1, an application scenario 100 of such embodiments may include an electronic device 110, which may be various electronic devices having processing functions, including but not limited to smart phones, tablet computers, laptop computers, desktop computers, servers, and so on. The electronic device 110 may perform, for example, a text detection on an input image 120 to obtain a position of a detected text in the image 120, that is, a text position 130.

According to embodiments of the present disclosure, the position of the text in the image 120 may be represented by, for example, a position of a bounding box of the text. The detection of the text in the image by the electronic device 110 may be used as a pre-step for tasks such as character recognition or scene understanding. For example, the detection of the text in the image may be applied to a document recognition, a bill recognition and other service scenes. By a pre-detection of the text, an execution efficiency of subsequent tasks may be improved, and a productivity of various application scenarios may be improved.

According to embodiments of the present disclosure, the electronic device 110 may perform a text detection by using, for example, an idea of object detection or object segmentation. The object detection is to locate a text by a regression of bounding box. Common algorithms for the object detection include Efficient and Accuracy Scene Text (EAST) algorithm, Detecting Text in Natural Image with Connectionist Text Proposal Network (CTPN) algorithm, and so on. These algorithms have a poor detection effect for a complex natural scene, such as a scene with a large font change or a scene with a severe scene interference. The object segmentation is to perform a pixel-wise classification prediction on the image by using a fully convolutional network, so as to divide the image into a text region and a non-text region, and then the pixel-level output may be converted into a form of a bounding box through subsequent processing. An algorithm that performs a text detection using the idea of object segmentation may use, for example, Mask-Region Convolutional Neural Network (Mask-RCNN) as a backbone network to generate a segmentation map. By using the idea of object segmentation for text detection, it is possible to achieve a high accuracy in a detection of a text in a normal horizontal direction, but it requires complex post-processing steps to generate a corresponding bounding box, which may undoubtedly consume a lot of computing resources and time. Furthermore, for a case of overlapping bounding boxes caused by overlapping texts, a text detection using the idea of object segmentation has a poor effect.

Based on this, in an embodiment, the electronic device 110 may perform a text detection on the image 120 by using a text detection model 150 trained by a method of training a text detection model described later. For example, the text detection model 150 may be trained by, for example, a server 140. The electronic device 110 may be communicatively connected to the server 140 through a network, so as to send a model acquisition request to the server 140. Accordingly, the server 140 may send the trained text detection model 150 to the electronic device 110 in response to the request.

In an embodiment, the electronic device 110 may also send the input image 120 to the server 140, and the server 140 performs a text detection on the image 120 based on the trained text detection model 150.

It should be noted that the method of training the text detection model provided in the present disclosure may generally be performed by the server 140, or may be performed by other servers communicatively connected to the server 140. Accordingly, the apparatus of training the text detection model provided by the present disclosure may be provided in the server 140, or may be provided in other servers communicatively connected to the server 140. The method of detecting the text by using the text detection model provided in the present disclosure may generally be performed by the electronic device 110, or may be performed by the server 140. Accordingly, the apparatus of detecting the text by using the text detection model provided in the present disclosure may be provided in the electronic device 110, or may be provided in the server 140.

It should be understood that a number and a type of electronic device 110 and server 140 in FIG. 1 are merely schematic. According to implementation needs, any number and type of electronic devices 110 and servers 140 may be provided.

The method of training the text detection model provided in the present disclosure will be describe in detail below through FIG. 2 to FIG. 6 in conjunction with FIG. 1.

FIG. 2 shows a schematic flowchart of a method of training a text detection model according to embodiments of the present disclosure.

As shown in FIG. 2, the method of training the text detection model in such embodiments may include operation S210 to operation S250. The text detection model includes a text feature extraction sub-model, a text encoding sub-model, a decoding sub-model, and an output sub-model.

In operation S210, a sample image containing a text is input into the text feature extraction sub-model to obtain a first text feature of the text contained in the sample image.

According to embodiments of the present disclosure, the text feature extraction sub-model may process the sample image containing the text, for example, by using a residual network or a self-attention network, so as to obtain a text feature of the text contained in the sample image.

In an embodiment, the feature extraction sub-model may include, for example, an image feature extraction network and a sequence encoding network. The image feature extraction network may adopt a convolutional neural network (for example, a ResNet network), or an encoder of a Transformer network based on an attention mechanism. The sequence encoding network may adopt a recurrent neural network, or an encoder in a Transformer network. In operation S210, the sample image may be input into the image feature extraction network to obtain an image feature of the sample image. Then the image feature is converted into a one-dimensional vector, and then the one-dimensional vector is input into the sequence encoding network to obtain the first text feature.

For example, when the image feature extraction network adopts an encoder of a Transformer network, such embodiments may be implemented to expand the sample image into a one-dimensional pixel vector, and then the one-dimensional pixel vector may be input into the image feature extraction model. An output of the image feature extraction network may be input into the sequence encoding network, so that a feature information of the text may be obtained from an overall feature of the image through the sequence encoding network. Through the sequence encoding model, for example, the obtained first text feature may also represent a context information of the text.

It may be understood that the sample image may have a label, and the label indicates an actual position information of the text contained in the sample image and an actual category for the actual position information. For example, the label may be represented by a coordinate position of a bounding box surrounding the text in a coordinate system established based on the sample image. The actual category for the actual position information indicated by the label may be an actual category of the bounding box surrounding the text, and the actual category is a category for which a text is contained. In this way, the label may also indicate an actual probability for the actual position information. If the actual category is the category for which a text is contained, the actual probability of containing text is 1.

In operation S220, a predetermined text vector is input into the text encoding sub-model to obtain a first text reference feature.

According to embodiments of the present disclosure, the text encoding sub-model may be, for example, a fully connected layer structure, so as to obtain the first text reference feature having a same dimension as the first text feature by processing the predetermined text vector. The predetermined text vector may be set according to actual needs. For example, if a maximum length of a text in an image is set to be generally 25, then the predetermined text vector may be a vector having 25 components, and values of the 25 components may be 1, 2, 3, . . . , 25, respectively.

It may be understood that the method of obtaining the first text reference feature by the text encoding sub-model is similar to a method of obtaining a position code by learning a position code. Through the text encoding sub-model, an independent vector may be learned for each character in the text.

In operation S230, the first text feature and the first text reference feature are input into the decoding sub-model to obtain a first text sequence vector.

According to embodiments of the present disclosure, the decoding sub-model may adopt a decoder of a Transformer model. The first text reference feature may be used as a reference feature (for example, as an object query) input into the decoding sub-model, and the first text feature may be used as a key feature (i.e., Key) and a value feature (i.e., Value) input into the decoding sub-model. After the processing of the decoding sub-model, the first text sequence vector may be obtained.

According to embodiments of the present disclosure, the first text sequence vector may include at least one text vector, and each text vector represents a text in the sample image. For example, if the sample image contains two lines of text, the first text sequence vector may include at least two text vectors.

In operation S240, the first text sequence vector is input into the output sub-model to obtain a predicted position information of the text contained in the sample image and a predicted category for the predicted position information.

According to embodiments of the present disclosure, the output sub-model may have, for example, two network branches, one network branch is used to regress a predicted position of the text, and the other network branch is used to classify the predicted position to obtain the predicted category. A classification result may be represented by a predicted probability to indicate a probability that a text is contained at the predicted position. If the probability of containing a text is greater than a probability threshold, the predicted category may be determined as a category for which a text is contained, otherwise the predicted category may be determined as a category for which no text is contained.

According to embodiments of the present disclosure, the two network branches may be, for example, respectively formed by feed-forward networks. An input of the network branch for regressing the predicted position of the text is the first text sequence vector, and an output is a predicted position of a bounding box of the text. An input of the network branch for classification is the first text sequence vector, and an output is a probability of a target category. The target category is the category for which a text is contained.

In operation S250, the text detection model is trained based on the predicted category, the actual category, the predicted position information and the actual position information.

According to embodiments of the present disclosure, after the predicted position information and the predicted category are obtained, it is possible to compare the predicted position information with the actual position information indicated by the label to obtain a positioning loss. The predicted category may be compared with the actual category indicated by the label to obtain a classification loss. The positioning loss may be represented by, for example, a hinge loss function, a smooth loss (e.g., Softmax Loss) function, and the like. The positioning loss may be represented by, for example, a Mean Absolute Error (also referred to as L1 loss), a Mean Square Error (also referred to as L2 loss), and the like. The classification loss may be determined by, for example, a difference between the predicted probability and the actual probability.

In such embodiments, a weighted sum of the positioning loss and the classification loss may be used as a loss of the text detection model. Weights used in calculating the weighted sum may be set according to actual needs, which is not limited in the present disclosure. After the loss of the text detection model is obtained, the text detection model may be trained using a back-propagation algorithm or the like.

In embodiments of the present disclosure, the text encoding sub-model is provided in the text detection model. In a process of training the text detection model, the text encoding sub-model may pay attention to different text instance information and provide more accurate reference information for the decoding sub-model, so that the text detection model has a stronger feature modeling ability, various texts in natural scenes may be detected more accurately, and a probability of missing or false detection of a text in an image may be reduced.

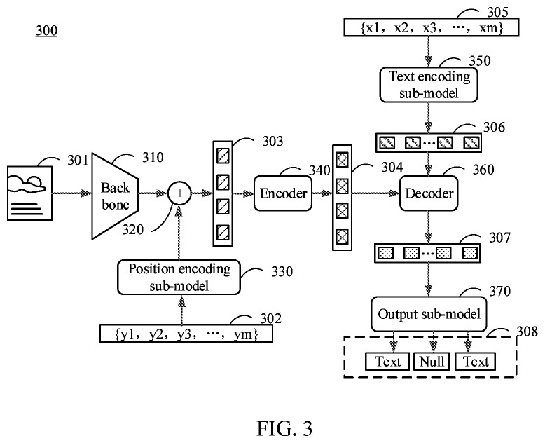

FIG. 3 shows a schematic structural diagram of a text detection model according to embodiments of the present disclosure.

According to embodiments of the present disclosure, as shown in FIG. 3, a text detection model 300 of such embodiments may include an image feature extraction network 310, a first position encoding sub-model 330, a sequence encoding network 340, a text encoding sub-model 350, a decoding sub-model 360, and an output sub-model 370. The image feature extraction network 310 and the first position encoding sub-model 330 constitute a text feature extraction sub-model.

In embodiments of the present disclosure, when detecting a text in a sample image, a sample image 301 may be input into the image feature extraction network 310 to obtain an image feature of the sample image. The image feature extraction network 310 may adopt a backbone network, such as an encoder of the above-mentioned ResNet network or Transformer network, in an image segmentation model, an image detection model, or the like. A predetermined position vector 302 is then input into the first position encoding sub-model 330 to obtain a position encoding feature. The first position encoding sub-model 330 may be similar to the above-mentioned text encoding sub-model, and may be a fully connected layer. The predetermined position vector 302 is similar to the above-mentioned predetermined text vector. The predetermined position vector 302 may be set according to actual needs. In an embodiment, a length of the predetermined position vector 302 may be the same as or different from that of a predetermined text vector 305, which is not limited in the present disclosure. Subsequently, the image feature and the position encoding feature may be fused by a fusion network 320. Specifically, the fusion network 320 may add the position encoding feature and the image feature. The feature obtained by adding the position encoding feature and the image feature may be input into the sequence encoding network 340 to obtain a first text feature 304. The sequence encoding network 340 may adopt an encoder of a Transformer model. Therefore, before being input into the sequence encoding network 340, the feature obtained by adding the position encoding feature and the image feature needs to be converted into a one-dimensional vector 303, and the one-dimensional vector 303 is used as an input of the sequence encoding network 340.

While, the predetermined text vector 305 may be input into the text encoding sub-model 350, and a first text reference feature 306 is output by the text encoding sub-model 350. Both the first text feature 304 output by the sequence encoding network 340 and the first text reference feature 306 may be used as the input of the decoding sub-model 360, and a first text sequence vector 307 is output through the decoding sub-model 360. The decoding sub-model 360 may adopt a decoder of a Transformer model.

After the first text sequence vector 307 output by the decoding sub-model 360 is input into the output sub-model 370, a position of a bounding box of the text and a category probability of the bounding box may be output by the output sub-model 370. A position of the bounding box in a coordinate system established based on the sample image is used as a predicted position information of the text, and a probability of containing a text indicated in the category probability of the bounding box is used as a predicted probability that a text is contained at the predicted position. A predicted category may be obtained based on the predicted probability. At least one bounding box 308 shown in FIG. 3 may be obtained based on the output of the output sub-model 370. When the probability of the bounding box containing a text is less than the probability threshold, the bounding box is regarded as a Null box, i.e., a box without text, otherwise the bounding box is regarded as a Text box, i.e., a box with text. The probability threshold may be set according to actual needs, which is not limited in the present disclosure.

In such embodiments, the text feature extraction sub-model includes the image feature extraction network and the sequence encoding network, and the position feature is added to the image feature before the image feature is input into the sequence encoding network, so that an expressivity of the obtained text feature for a context information of the text may be improved, and the text may be detected more accurately. By providing the first position encoding sub-model, the sequence encoding network may adopt a Transformer architecture, so that a calculation efficiency is improved and an expressivity for a long text is enhanced compared with a recurrent neural network architecture.

According to embodiments of the present disclosure, in the text detection model of such embodiments, for example, a convolutional layer may be further provided between the sequence encoding network and the fusion network, and a size of the convolutional layer may be 1×1, so that a dimension of the fused vector may be reduced so as to reduce a computation of the sequence encoding network. In a task of text detection, a requirement for a resolution of a feature is not high, and the computation of the model may be reduced by sacrificing the resolution to a certain extent.

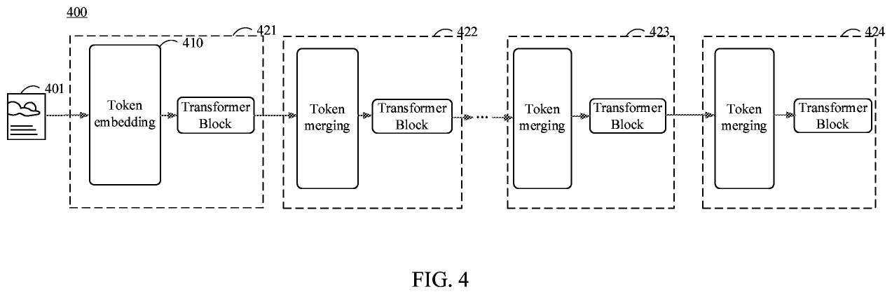

FIG. 4 shows a schematic structural diagram of an image feature extraction network according to embodiments of the present disclosure.

According to embodiments of the present disclosure, in an embodiment 400, the above-mentioned image feature extraction network may include: a feature conversion unit 410; and a plurality of feature processing units 421 to 424 connected in sequence. Each feature processing unit may adopt a decoder structure of a Transformer architecture.

The feature conversion unit 410 may be an embedding layer, which is used to obtain a one-dimensional vector representing the sample image based on the sample image 401. Through the feature conversion unit, a character in the image may be used as a token and represented by an element in the vector. In an embodiment, the feature conversion unit 410 may be used, for example, to expand and convert a pixel matrix in the image into a one-dimensional vector of a fixed size. The one-dimensional vector may be input into a first feature processing unit 421 among the plurality of feature processing units, and sequentially processed by the plurality of feature processing units connected in sequence, and then an image feature of the sample image may be obtained. Specifically, the one-dimensional vector may be processed by the first feature processing unit 421 to output a feature map. The feature map is input into the second feature processing unit 422, a feature map output by the second feature processing unit 422 is input into the third feature processing unit, and so on. A feature map output by the last feature processing unit 424 among the plurality of feature processing units is the image feature of the sample image. That is, for an i^{th} feature processing unit among the plurality of feature processing units other than the first feature processing unit 421, the feature map output by an (i−1)^{th} feature processing unit is input into the i^{th} feature processing unit, and the feature map for the i^{th} feature processing unit is output, where i≥2. Finally, according to a connection sequence, the feature map output by the last feature processing unit among the plurality of feature processing units is used as the image feature of the sample image.

According to such embodiments, the image feature extraction network adopts a hierarchical design that may include a plurality of feature extraction stages, and each feature processing unit corresponds to one feature extraction stage. In such embodiments, resolutions of the feature maps output by the plurality of feature processing units may be successively reduced according to the connection sequence, so as to expand a receptive field layer by layer, similar to CNN.

It may be understood that, as shown in FIG. 4, a feature processing unit other than the first feature processing unit 421 may include a token merging layer and an encoding block (i.e., Transformer Block) in the Transformer architecture. The token merging layer is used to down-sample a feature. The encoding block is used to encode the feature. A structure corresponding to the token merging layer in the first feature processing unit 421 may be the above-mentioned feature conversion unit 410, so as to process the sample image to obtain the input of the encoding block in the first feature processing unit, that is, to obtain the above-mentioned one-dimensional feature.

It may be understood that each feature processing unit may include at least one basic element composed of a token merging layer and an encoding block. In a case of a plurality of basic elements, the plurality of basic elements may be connected in sequence. It should be noted that if the first feature processing unit includes a plurality of basic elements, a token merging layer in a first basic element that is ranked first in the first feature processing unit may be used as the feature conversion unit 410, and a token merging layer in a basic element other than the first basic element is similar to a token merging layer in the feature processing unit other than the first feature processing unit. For example, in an embodiment, in a case of four feature processing units, the four feature processing units sequentially include two basic elements, two basic elements, six basic elements and two basic elements according to the connection sequence, which is not limited in the present disclosure.

In an embodiment, as the plurality of feature processing units adopt an encoder structure of a Transformer architecture, a position encoding may be performed on the sample image before obtaining the one-dimensional vector input into the first feature processing unit. Specifically, the text detection model adopted in such embodiments may further include a second position encoding sub-model. A position encoding may be performed on the sample image by using the second position encoding sub-model, so as to obtain a position map of the sample image. Here, when performing the position encoding on the sample image, a method of learning a position code or an absolute position encoding method may be used to obtain the position map. The absolute position encoding method may include a trigonometric function encoding method, which is not limited in the present disclosure. After the position code is obtained, such embodiments may be implemented to pixel-wise add the sample image and the position map, and then input the added data into the feature conversion unit, so as to obtain a one-dimensional vector representing the sample image. Specifically, it is possible to add a pixel matrix representing the sample image and a pixel matrix representing the position map to implement the pixel-wise addition between the sample image and the position map.

Different from a technical solution using CNN, in this solution, an encoder structure of a Transformer architecture is used as the image feature extraction network, and the position information is fused, so that the obtained image feature may better express a long-distance context information of an image, and a learning ability and a prediction effect of the model may be improved.

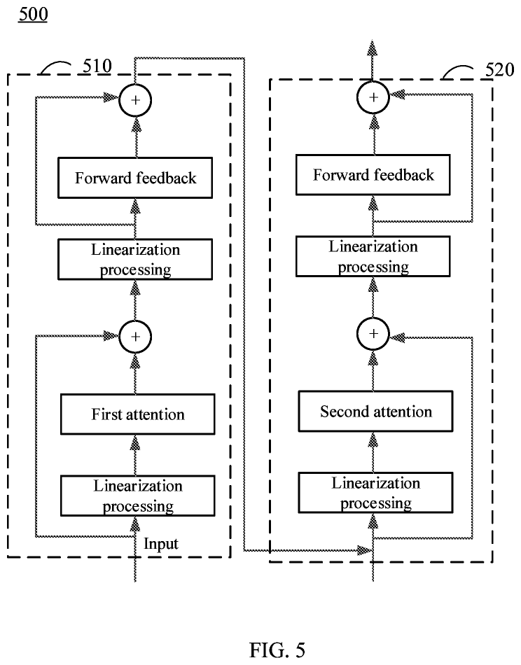

FIG. 5 shows a schematic structural diagram of a feature processing unit according to embodiments of the present disclosure.

According to embodiments of the present disclosure, as shown in FIG. 5, each feature processing unit 500 among a plurality of feature processing units includes an even number of encoding layers connected in sequence. For the even number of encoding layers, a shifted window of an odd-numbered encoding layer 510 is smaller than a shifted window of an even-numbered encoding layer 520. In such embodiments, when a first feature processing unit among the plurality of feature processing units is used to obtain a feature map for the first feature processing unit, the one-dimensional vector may be input into a first encoding layer among the even number of encoding layers included in the first feature processing unit, and sequentially processed by the even number of encoding layers connected in sequence, so as to obtain the feature map for the first feature processing unit. Specifically, the one-dimensional vector may be input into the first encoding layer among the even number of encoding layers included in the first feature processing unit, and a feature map for the first encoding layer is output. For a j^{th} encoding layer among the even number of encoding layers included in the first feature processing unit other than the first encoding layer, the feature map output by a (j−1)^{th} encoding layer is input into the j^{th} encoding layer, and the feature map for the j^{th} encoding layer is output, where j≥2. Finally, according to the connection sequence, the feature map output by the last encoding layer among the even number of encoding layers included in the first feature processing unit is used as the feature map for the first feature processing unit.

As shown in FIG. 5, a feature processing unit 500 is similar to an encoder structure of a Transformer architecture in a related art, each encoding layer includes an attention layer and a feed-forward layer, and each of the attention layer and the feed-forward layer is provided with a linearization processing layer. For the odd-numbered encoding layer, the attention layer adopts a first attention provided with a first shifted window, so as to divide the input feature vector into blocks and concentrate a calculation of attention within each feature vector block. As the attention layer may calculate in parallel, a plurality of divided feature vector blocks may be calculated in parallel, so that the computation may be greatly reduced compared with calculating an entire input feature vector. For the even-numbered encoding layer, the attention layer adopts a second attention provided with a second shifted window larger than the first shifted window. The second shifted window may be, for example, the entire feature vector. As the input of the even-numbered encoding layer is the output of the odd-numbered encoding layer, the even-numbered encoding layer may perform a calculation of attention between features in a feature sequence output by the odd-numbered encoding layer, with each feature in the feature sequence as a basic unit, so as to ensure an interactive flow of information between the plurality of feature vector blocks divided by the first shifted window. By providing the two attention layers and providing two shifted windows with different sizes, a feature extraction ability of the image feature extraction model may be improved.

It may be understood that in embodiments of the present disclosure, the feature processing unit substantially adopts an encoder structure of a Transformer architecture with a sliding window mechanism. For the i^{th} feature processing unit other than the first feature processing unit, the input feature map is sequentially processed by the even number of encoding layers connected in sequence in the i^{th} feature processing unit, and the feature map for the i^{th} feature processing unit is output by the last encoding layer.

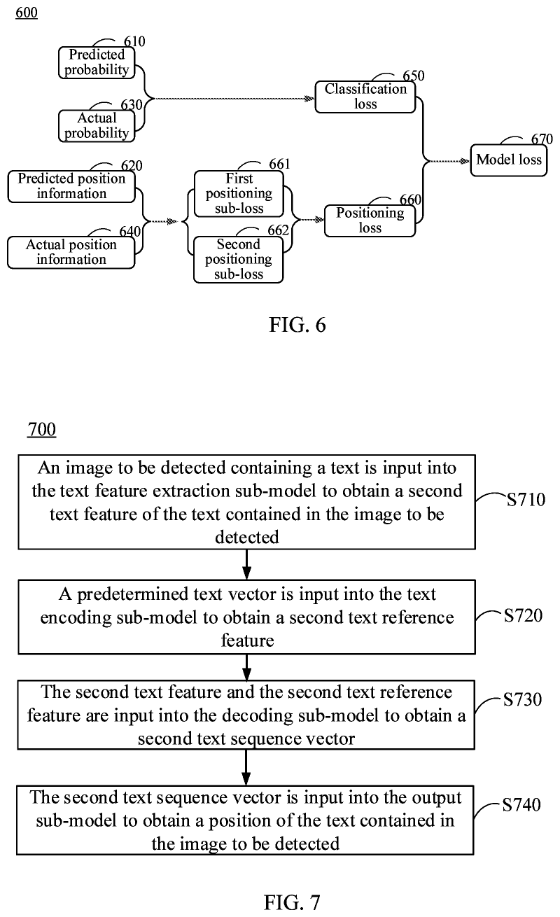

FIG. 6 shows a schematic diagram of determining a loss of a text detection model according to embodiments of the present disclosure.

According to embodiments of the present disclosure, in an embodiment 600, a predicted position information may be represented by, for example, four predicted position points, and an actual position information may be represented by four actual position points. The four predicted position points may be an upper left vertex, an upper right vertex, a lower right vertex and a lower left vertex of a predicted bounding box. The four actual position points may be an upper left vertex, an upper right vertex, a lower right vertex and a lower left vertex of an actual bounding box. Different from a technical solution of representing a position using a center point, a length and a width of the bounding box in the related art, the bounding box may be allowed to be other shapes than rectangle. That is, in such embodiments, a rectangular box form in the related art may be converted into a four-point box form, so that the text detection model is better applicable to perform a text detection task in a complex scene.

In such embodiments, when determining a loss of the text detection model, it is possible to determine a classification loss 650 of the text detection model based on an obtained predicted probability 610 and an actual probability 630 indicated by a label, and determine a positioning loss 660 of the text detection model based on an obtained predicted position information 620 and an actual position information 640 indicated by the label. Finally, the loss of the text detection model, that is, a model loss 670, may be obtained based on the classification loss 650 and the positioning loss 660, so that the text detection model may be trained based on the model loss 670.

According to embodiments of the present disclosure, the positioning loss 660 in such embodiments may be represented by, for example, a weighted sum of a first positioning sub-loss 651 and a second positioning sub-loss 652. The first positioning sub-loss 651 may be calculated based on distances between the four actual position points and the four predicted position points respectively. The second positioning sub-loss 652 may be calculated based on Intersection over Union between a region enclosed by the four actual position points and a region enclosed by the four predicted position points. Weights used for calculating the weighted sum of the first positioning sub-loss 651 and the second positioning sub-loss 652 may be set according to actual needs, which is not limited in the present disclosure.

For example, the first positioning sub-loss 651 may be represented by the above-mentioned L1 loss or L2 loss, etc., and the second positioning sub-loss 652 may be represented by Intersection over Union. Alternatively, the second positioning sub-loss 652 may be represented by any loss function positively correlated with Intersection over Union, which is not limited in the present disclosure.

In embodiments of the present disclosure, by providing the second positioning sub-loss, the obtained positioning loss may better reflect a difference between the predicted bounding box represented by the four position points and the actual bounding box represented by the four position points, and the positioning loss may be obtained more accurately.

Based on the above-mentioned method of training the text detection model, the present disclosure further provides a method of detecting a text by using the trained text detection model, which will be described in detail below with reference to FIG. 7.

FIG. 7 shows a schematic flowchart of a method of detecting a text by using a text detection model according to embodiments of the present disclosure.

As shown in FIG. 7, a method 700 of such embodiments may include operation S710 to operation S740. The text detection model is trained by using the method of training the text detection model described above. The text detection model may include a text feature extraction sub-model, a text encoding sub-model, a decoding sub-model, and an output sub-model.

In operation S710, an image to be detected containing a text is input into the text feature extraction sub-model to obtain a second text feature of the text contained in the image to be detected. It may be understood that a method of obtaining the second text feature is similar to the method of obtaining the first text feature, which will not be repeated here.

In operation S720, a predetermined text vector is input into the text encoding sub-model to obtain a second text reference feature. It may be understood that a method of obtaining the second text reference feature is similar to the method of obtaining the first text reference feature, which will not be repeated here.

In operation S730, the second text feature and the second text reference feature are input into the decoding sub-model to obtain a second text sequence vector. It may be understood that a method of obtaining the second text sequence vector is similar to the method of obtaining the first text sequence vector, which will not be repeated here.

In operation S740, the second text sequence vector is input into the output sub-model to obtain a position of the text contained in the image to be detected.

It may be understood that in embodiments of the present disclosure, the output of the output sub-model may include the above-mentioned predicted position information and predicted probability. In such embodiments, a coordinate position representing the predicted position information for which a predicted probability is greater than a probability threshold may be used as the position of the text contained in the detected image.

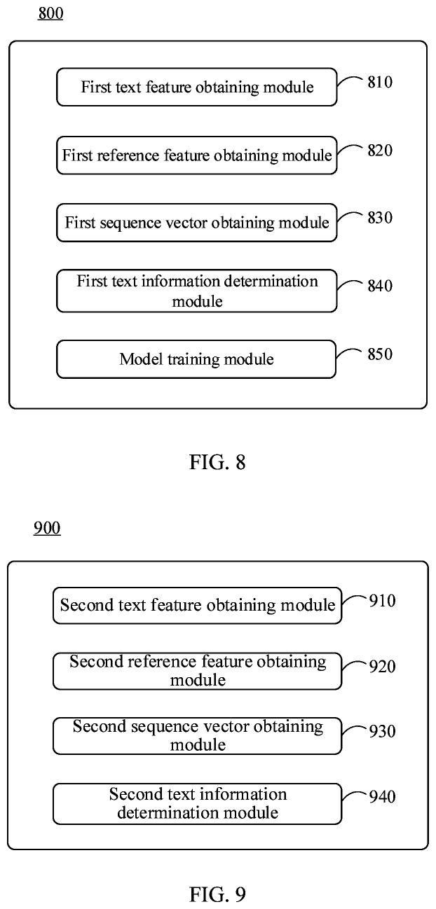

Based on the above-mentioned method of training the text detection model, the present disclosure further provides an apparatus of training a text detection model, which will be described in detail below with reference to FIG. 8.

FIG. 8 shows a structural block diagram of an apparatus of training a text detection model according to embodiments of the present disclosure.

As shown in FIG. 8, an apparatus 800 in such embodiments may include a first text feature obtaining module 810, a first reference feature obtaining module 820, a first sequence vector obtaining module 830, a first text information determination module 840, and a model training module 850. The text detection model includes a text feature extraction sub-model, a text encoding sub-model, a decoding sub-model and an output sub-model.

The first text feature obtaining module 810 may be used to input a sample image containing a text into the text feature extraction sub-model to obtain a first text feature of the text contained in the sample image. The sample image has a label indicating an actual position information of the text contained in the sample image and an actual category for the actual position information. In an embodiment, the first text feature obtaining module 810 may be used to perform operation S210 described above, which will not be repeated here.

The first reference feature obtaining module 820 may be used to input a predetermined text vector into the text encoding sub-model to obtain a first text reference feature. In an embodiment, the first reference feature obtaining module 820 may be used to perform operation S220 described above, which will not be repeated here.

The first sequence vector obtaining module 830 may be used to input the first text feature and the first text reference feature into the decoding sub-model to obtain a first text sequence vector. In an embodiment, the first sequence vector obtaining module 830 may be used to perform operation S230 described above, which will not be repeated here.

The first text information determination module 840 may be used to input the first text sequence vector into the output sub-model to obtain a predicted position information of the text contained in the sample image and a predicted category for the predicted position information. In an embodiment, the first text information determination module 840 may be used to perform operation S240 described above, which will not be repeated here.

The model training module 850 may be used to train the text detection model based on the predicted category, the actual category, the predicted position information and the actual position information. In an embodiment, the model training module 850 may be used to perform operation S250 described above, which will not be repeated here.

According to embodiments of the present disclosure, the text feature extraction sub-model includes an image feature extraction network and a sequence encoding network; the text detection model further includes a first position encoding sub-model. The first text feature obtaining module 810 includes an image feature obtaining sub-module, a position feature obtaining sub-module, and a text feature obtaining sub-module. The image feature obtaining sub-module may be used to input the sample image into the image feature extraction network to obtain an image feature of the sample image. The position feature obtaining sub-module may be used to input a predetermined position vector into the first position encoding sub-model to obtain a position encoding feature. The text feature obtaining sub-module may be used to add the position encoding feature and the image feature, and input the added position encoding feature and image feature into the sequence encoding network to obtain the first text feature.

According to embodiments of the present disclosure, the image feature extraction network includes a plurality of feature processing units connected in sequence and a feature conversion unit. The image feature obtaining sub-module includes a one-dimensional vector obtaining unit and a feature obtaining unit. The one-dimensional vector obtaining unit may be used to obtain, by using the feature conversion unit, a one-dimensional vector representing the sample image based on the sample image. The feature obtaining unit may be used to input the one-dimensional vector into a first feature processing unit among the plurality of feature processing units, so that the one-dimensional vector is sequentially processed by the plurality of feature processing units to obtain the image feature of the sample image, where resolutions of feature maps output by the plurality of feature processing units are sequentially reduced according to a connection sequence.

According to embodiments of the present disclosure, each of the plurality of feature processing units includes an even number of encoding layers connected in sequence. For the even number of encoding layers, a shifted window of an odd-numbered encoding layer is smaller than a shifted window of an even-numbered encoding layer. The feature obtaining unit is used to obtain a feature map for the first feature processing unit by: inputting the one-dimensional vector into a first encoding layer among the even number of encoding layers in the first feature processing unit, so that the one-dimensional vector is sequentially processed by the even number of encoding layers to obtain the feature map for the first feature processing unit.

According to embodiments of the present disclosure, the text detection model further includes a second position encoding sub-model. The one-dimensional vector obtaining unit is further used to: obtain, by using the second position encoding sub-model, a position map of the sample image based on the sample image; and pixel-wise add the sample image and the position map and input the added sample image and position map into the feature conversion unit to obtain the one-dimensional vector representing the sample image.

According to embodiments of the present disclosure, the model training module 850 includes a classification loss determination sub-module, a positioning loss determination sub-module, and a model training sub-module. The classification loss determination sub-module may be used to determine a classification loss of the text detection model based on the predicted category and the actual category. The positioning loss determination sub-module may be used to determine a positioning loss of the text detection model based on the predicted position information and the actual position information. The model training sub-module may be used to train the text detection model based on the classification loss and the positioning loss.

According to embodiments of the present disclosure, the actual position information is represented by four actual position points; the predicted position information is represented by four predicted position points; the positioning loss determination sub-module includes a first determination unit, a second determination unit, and a third determination unit. The first determination unit may be used to determine a first positioning sub-loss based on distances between the four actual position points and the four predicted position points respectively. The second determination unit may be used to determine a second positioning sub-loss based on Intersection over Union between a region enclosed by the four actual position points and a region enclosed by the four predicted position points. The third determination unit may be used to determine a weighted sum of the first positioning sub-loss and the second positioning sub-loss as the positioning loss of the text detection model.

Based on the above-mentioned method of detecting the text by using the text detection model, the present disclosure further provides an apparatus of detecting a text by using a text detection model, which will be described in detail below with reference to FIG. 9.

FIG. 9 shows a structural block diagram of an apparatus of detecting a text by using a text detection model according to embodiments of the present disclosure.

As shown in FIG. 9, an apparatus 900 in such embodiments may include a second text feature obtaining module 910, a second reference feature obtaining module 920, a second sequence vector obtaining module 930, and a second text information determination module 940. The text detection model includes a text feature extraction sub-model, a text encoding sub-model, a decoding sub-model and an output sub-model. The text detection model may be trained using the apparatus of training the text detection model described above.

The second text feature obtaining module 910 may be used to input an image to be detected containing a text into the text feature extraction sub-model to obtain a second text feature of the text contained in the image to be detected. In an embodiment, the second text feature obtaining module 910 may be used to perform operation S710 described above, which will not be repeated here.

The second reference feature obtaining module 920 may be used to input a predetermined text vector into the text encoding sub-model to obtain a second text reference feature. In an embodiment, the second reference feature obtaining module 920 may be used to perform operation S720 described above, which will not be repeated here.

The second sequence vector obtaining module 930 may be used to input the second text feature and the second text reference feature into the decoding sub-model to obtain a second text sequence vector. In an embodiment, the second sequence vector obtaining module 930 may be used to perform operation S730 described above, which will not be repeated here.

The second text information determination module 940 may be used to input the second text sequence vector into the output sub-model to obtain a position of the text contained in the image to be detected. In an embodiment, the second text information determination module 940 may be used to perform operation S740 described above, which will not be repeated here.

In technical solutions of the present disclosure, a collection, a storage, a use, a processing, a transmission, a provision, a disclosure, an application and other processing of user personal information involved comply with provisions of relevant laws and regulations, take necessary security measures, and do not violate public order and good custom.

In the technical solutions of the present disclosure, the acquisition or collection of user personal information has been authorized or allowed by users.

According to embodiments of the present disclosure, the present disclosure further provides an electronic device, a readable storage medium, and a computer program product.

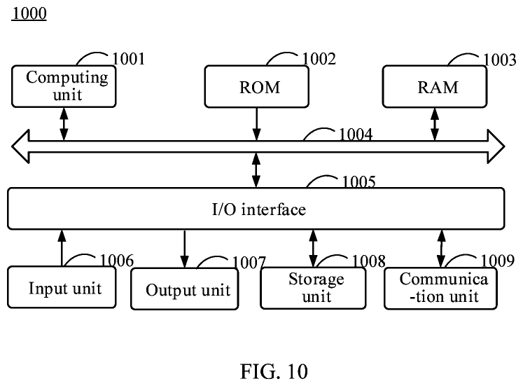

FIG. 10 shows a schematic block diagram of an example electronic device 1000 for implementing the method of training the text detection model and/or the method of detecting the text by using the text detection model in embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 10, the electronic device 1000 includes a computing unit 1001 which may perform various appropriate actions and processes according to a computer program stored in a read only memory (ROM) 1002 or a computer program loaded from a storage unit 1008 into a random access memory (RAM) 1003. In the RAM 1003, various programs and data necessary for an operation of the electronic device 1000 may also be stored. The computing unit 1001, the ROM 1002 and the RAM 1003 are connected to each other through a bus 1004. An input/output (I/O) interface 1005 is also connected to the bus 1004.

A plurality of components in the electronic device 1000 are connected to the I/O interface 1005, including: an input unit 1006, such as a keyboard, or a mouse; an output unit 1007, such as displays or speakers of various types; a storage unit 1008, such as a disk, or an optical disc; and a communication unit 1009, such as a network card, a modem, or a wireless communication transceiver. The communication unit 1009 allows the electronic device 1000 to exchange information/data with other devices through a computer network such as Internet and/or various telecommunication networks.

The computing unit 1001 may be various general-purpose and/or dedicated processing assemblies having processing and computing capabilities. Some examples of the computing units 1001 include, but are not limited to, a central processing unit (CPU), a graphics processing unit (GPU), various dedicated artificial intelligence (AI) computing chips, various computing units that run machine learning model algorithms, a digital signal processing processor (DSP), and any suitable processor, controller, microcontroller, etc. The computing unit 1001 executes various methods and processes described above, such as the method of training the text detection model and/or the method of detecting the text by using the text detection model. For example, in some embodiments, the method of training the text detection model and/or the method of detecting the text by using the text detection model may be implemented as a computer software program which is tangibly embodied in a machine-readable medium, such as the storage unit 1008. In some embodiments, the computer program may be partially or entirely loaded and/or installed in the electronic device 1000 via the ROM 1002 and/or the communication unit 1009. The computer program, when loaded in the RAM 1003 and executed by the computing unit 1001, may execute one or more steps in the method of training the text detection model and/or the method of detecting the text by using the text detection model described above. Alternatively, in other embodiments, the computing unit 1001 may be used to perform the method of training the text detection model and/or the method of detecting the text by using the text detection model by any other suitable means (e.g., by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from a storage system, at least one input device and at least one output device, and may transmit the data and instructions to the storage system, the at least one input device, and the at least one output device.

Program codes for implementing the methods of the present disclosure may be written in one programming language or any combination of more programming languages. These program codes may be provided to a processor or controller of a general-purpose computer, a dedicated computer or other programmable data processing apparatus, such that the program codes, when executed by the processor or controller, cause the functions/operations specified in the flowcharts and/or block diagrams to be implemented. The program codes may be executed entirely on a machine, partially on a machine, partially on a machine and partially on a remote machine as a stand-alone software package or entirely on a remote machine or server.

In the context of the present disclosure, a machine-readable medium may be a tangible medium that may contain or store a program for use by or in connection with an instruction execution system, an apparatus or a device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer disk, a hard disk, a random access memory (RAM), a read only memory (ROM), an erasable programmable read only memory (EPROM or a flash memory), an optical fiber, a compact disk read only memory (CD-ROM), an optical storage device, a magnetic storage device, or any suitable combination of the above.

In order to provide interaction with the user, the systems and technologies described here may be implemented on a computer including a display device (for example, a CRT (cathode ray tube) or LCD (liquid crystal display) monitor) for displaying information to the user, and a keyboard and a pointing device (for example, a mouse or a trackball) through which the user may provide the input to the computer. Other types of devices may also be used to provide interaction with the user. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and the Internet.

The computer system may include a client and a server. The client and the server are generally far away from each other and usually interact through a communication network. A relationship between the client and the server is generated through computer programs running on the corresponding computers and having a client-server relationship with each other. The server may be a cloud server, also known as a cloud computing server or a cloud host, which is a host product in a cloud computing service system to solve shortcomings of difficult management and weak service scalability existing in an existing physical host and VPS (Virtual Private Server) service. The server may also be a server of a distributed system or a server combined with a block-chain.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

1. A method of training a text detection model, wherein the text detection model comprises a text feature extraction sub-model, a text encoding sub-model, a decoding sub-model and an output sub-model,
the method comprising:
inputting a sample image containing a text into the text feature extraction sub-model to obtain a first text feature of the text contained in the sample image, wherein the sample image has a label indicating an actual position information of the text contained in the sample image and an actual category for the actual position information;
inputting a predetermined text vector into the text encoding sub-model to obtain a first text reference feature;
inputting the first text feature and the first text reference feature into the decoding sub-model to obtain a first text sequence vector;
inputting the first text sequence vector into the output sub-model to obtain a predicted position information of the text contained in the sample image and a predicted category for the predicted position information; and
training the text detection model based on the predicted category, the actual category, the predicted position information and the actual position information.

2. The method according to claim 1, wherein the text feature extraction sub-model comprises an image feature extraction network and a sequence encoding network, and the text detection model further comprises a first position encoding sub-model, and
wherein obtaining the first text feature of the text contained in the sample image comprises:
inputting the sample image into the image feature extraction network to obtain an image feature of the sample image;
inputting a predetermined position vector into the first position encoding sub-model to obtain a position encoding feature; and
adding the position encoding feature and the image feature, and inputting the added position encoding feature and image feature into the sequence encoding network to obtain the first text feature.

3. The method according to claim 2, wherein the image feature extraction network comprises a plurality of feature processing units connected in sequence and a feature conversion unit, and
wherein obtaining the image feature of the sample image comprises:
obtaining, by using the feature conversion unit, a one-dimensional vector representing the sample image based on the sample image; and
inputting the one-dimensional vector into a first feature processing unit among the plurality of feature processing units, so that the one-dimensional vector is sequentially processed by the plurality of feature processing units to obtain the image feature of the sample image, wherein resolutions of feature maps output by the plurality of feature processing units are sequentially reduced according to a connection sequence.

4. The method according to claim 3, wherein each of the plurality of feature processing units comprises an even number of encoding layers connected in sequence, and for the even number of encoding layers, a shifted window of an odd-numbered encoding layer is smaller than a shifted window of an even-numbered encoding layer, and
wherein obtaining a feature map for the first feature processing unit by using the first feature processing unit among the plurality of feature processing units comprises:
inputting the one-dimensional vector into a first encoding layer among the even number of encoding layers in the first feature processing unit, so that the one-dimensional vector is sequentially processed by the even number of encoding layers to obtain the feature map for the first feature processing unit.

5. The method according to claim 3, wherein the text detection model further comprises a second position encoding sub-model, and
wherein the obtaining, by using the feature conversion unit, a one-dimensional vector representing the sample image comprises:
obtaining, by using the second position encoding sub-model, a position map of the sample image based on the sample image; and
pixel-wise adding the sample image and the position map, and inputting the added sample image and position map into the feature conversion unit to obtain the one-dimensional vector representing the sample image.

6. The method according to claim 1, wherein the training the text detection model comprises:
determining a classification loss of the text detection model based on the predicted category and the actual category;
determining a positioning loss of the text detection model based on the predicted position information and the actual position information; and
training the text detection model based on the classification loss and the positioning loss.

7. The method according to claim 6, wherein the actual position information is represented by four actual position points, and the predicted position information is represented by four predicted position points, and
wherein the determining a positioning loss of the text detection model comprises:
determining a first positioning sub-loss based on distances between the four actual position points and the four predicted position points respectively;
determining a second positioning sub-loss based on Intersection over Union between a region enclosed by the four actual position points and a region enclosed by the four predicted position points; and
determining a weighted sum of the first positioning sub-loss and the second positioning sub-loss as the positioning loss of the text detection model.

8. A method of detecting a text by using a text detection model, wherein the text detection model comprises a text feature extraction sub-model, a text encoding sub-model, a decoding sub-model and an output sub-model,
the method comprising:
inputting an image to be detected containing a text into the text feature extraction sub-model to obtain a second text feature of the text contained in the image to be detected;
inputting a predetermined text vector into the text encoding sub-model to obtain a second text reference feature;
inputting the second text feature and the second text reference feature into the decoding sub-model to obtain a second text sequence vector; and
inputting the second text sequence vector into the output sub-model to obtain a position of the text contained in the image to be detected,
wherein the text detection model is trained using the method of claim 1.

9-16. (canceled)

17. An electronic device, comprising:
at least one processor; and
a memory communicatively connected to the at least one processor, wherein the memory stores instructions executable by the at least one processor, and the instructions, when executed by the at least one processor, cause the at least one processor to implement the method of claim 1.

18. A non-transitory computer-readable storage medium having computer instructions therein, wherein the computer instructions are configured to cause a computer to implement the method of claim 1.

19. (canceled)

20. The electronic device according to claim 17, wherein the text feature extraction sub-model comprises an image feature extraction network and a sequence encoding network, and the text detection model further comprises a first position encoding sub-model, and
wherein the instructions are further configured to cause the at least one processor to at least:
input the sample image into the image feature extraction network to obtain an image feature of the sample image;
input a predetermined position vector into the first position encoding sub-model to obtain a position encoding feature; and
add the position encoding feature and the image feature, and input the added position encoding feature and image feature into the sequence encoding network to obtain the first text feature.

21. The electronic device according to claim 20, wherein the image feature extraction network comprises a plurality of feature processing units connected in sequence and a feature conversion unit, and
wherein the instructions are further configured to cause the at least one processor to at least:
obtain, by using the feature conversion unit, a one-dimensional vector representing the sample image based on the sample image; and
input the one-dimensional vector into a first feature processing unit among the plurality of feature processing units, so that the one-dimensional vector is sequentially processed by the plurality of feature processing units to obtain the image feature of the sample image, wherein resolutions of feature maps output by the plurality of feature processing units are sequentially reduced according to a connection sequence.

22. The electronic device according to claim 21, wherein each of the plurality of feature processing units comprises an even number of encoding layers connected in sequence, and for the even number of encoding layers, a shifted window of an odd-numbered encoding layer is smaller than a shifted window of an even-numbered encoding layer, and
wherein the instructions are further configured to cause the at least one processor to at least:
input the one-dimensional vector into a first encoding layer among the even number of encoding layers in the first feature processing unit, so that the one-dimensional vector is sequentially processed by the even number of encoding layers to obtain the feature map for the first feature processing unit.

23. The electronic device according to claim 21, wherein the text detection model further comprises a second position encoding sub-model, and
wherein the instructions are further configured to cause the at least one processor to at least:
obtain, by using the second position encoding sub-model, a position map of the sample image based on the sample image; and
pixel-wise add the sample image and the position map, and input the added sample image and position map into the feature conversion unit to obtain the one-dimensional vector representing the sample image.

24. The electronic device according to claim 17, wherein the instructions are further configured to cause the at least one processor to at least:
determine a classification loss of the text detection model based on the predicted category and the actual category;
determine a positioning loss of the text detection model based on the predicted position information and the actual position information; and
train the text detection model based on the classification loss and the positioning loss.

25. The electronic device according to claim 24, wherein the actual position information is represented by four actual position points, and the predicted position information is represented by four predicted position points, and
wherein the instructions are further configured to cause the at least one processor to at least:
determine a first positioning sub-loss based on distances between the four actual position points and the four predicted position points respectively;
determine a second positioning sub-loss based on Intersection over Union between a region enclosed by the four actual position points and a region enclosed by the four predicted position points; and
determine a weighted sum of the first positioning sub-loss and the second positioning sub-loss as the positioning loss of the text detection model.

26. An electronic device, comprising:
at least one processor; and
a memory communicatively connected to the at least one processor, wherein the memory stores instructions executable by the at least one processor, and the instructions, when executed by the at least one processor, cause the at least one processor to implement the method of claim 8.

27. The non-transitory computer-readable storage medium according to claim 18, wherein the text feature extraction sub-model comprises an image feature extraction network and a sequence encoding network, and the text detection model further comprises a first position encoding sub-model, and
wherein the computer instructions are further configured to cause the computer to at least:
input the sample image into the image feature extraction network to obtain an image feature of the sample image;
input a predetermined position vector into the first position encoding sub-model to obtain a position encoding feature; and
add the position encoding feature and the image feature, and input the added position encoding feature and image feature into the sequence encoding network to obtain the first text feature.

28. The non-transitory computer-readable storage medium according to claim 27, wherein the image feature extraction network comprises a plurality of feature processing units connected in sequence and a feature conversion unit, and
wherein the computer instructions are further configured to cause the computer to at least:
obtain, by using the feature conversion unit, a one-dimensional vector representing the sample image based on the sample image; and
input the one-dimensional vector into a first feature processing unit among the plurality of feature processing units, so that the one-dimensional vector is sequentially processed by the plurality of feature processing units to obtain the image feature of the sample image, wherein resolutions of feature maps output by the plurality of feature processing units are sequentially reduced according to a connection sequence.

29. A non-transitory computer-readable storage medium having computer instructions therein, wherein the computer instructions are configured to cause a computer to implement the method of claim 8.
